(19) United States
(12) Patent Application Publication
(10) Pub. No.: US 2022/0395018 A1
(43) Pub. Date: Dec. 15, 2022

(54) Deeply Embossed Highly Permeable Cigarette Paper

(71) Applicant: JT International SA, Geneva (CH)

(72) Inventors: Ryo Kitaoka, Tokyo (JP); Hiroyoshi Ono, Tokyo (JP)

(73) Assignee: JT International SA, Geneva (CH)

(21) Appl. No.: 17/770,078

(22) PCT Filed: Oct. 23, 2020
(86) PCT No.: PCT/EP2020/079862

§ 371 Date: Apr. 19, 2022

(30) Foreign Application Priority Data
Oct. 23, 2019 (EP) 19204803.1

(51) Int. Cl. A24D 1/02; A24D 1/20; A24C 5/00; A24C 5/01; B31F 1/07; D21H 27/02

(52) U.S. Cl. CPC A24D 1/025; A24D 1/20; A24C 5/005; A24C 5/01; B31F 1/07; D21H 27/02; B31F 2201/0717

(57) ABSTRACT

A smoking article wrapper includes a non-perforated air permeable base paper having a naturally high porosity of 40-80 cm³/min air passing through a sample of 1 cm² of this base paper at an applied pressure difference of 1 kPa, wherein the smoking article wrapper has at least one embossed surface area and at least one non-embossed surface area. The air permeability of the smoking article wrapper is such that it provides a mean volumetric flow rate of ≥40 cm³/min air passing through a sample of 1 cm² of this smoking article wrapper at an applied pressure difference of 1 kPa. The embossed area includes an embossing having a depth of ≥16 μm. A smoking article including the smoking article wrapper and respective methods to produce such a smoking article wrapper and a smoking article are also provided.

### CROSS-REFERENCE TO RELATED APPLICATIONS

The present application is a national phase entry under 35 U.S.C. § 371 of International Application No. PCT/EP2020/079862, filed Oct. 23, 2020, published in English, which claims priority to European Patent Application No. 19204803.1 filed Oct. 23, 2019, the disclosures of which are incorporated herein by reference.

### BACKGROUND OF THE INVENTION

The present invention relates to a smoking article wrapper and a method for producing such a smoking article wrapper according to the preamble of present claims 1 and 13.

Furthermore, the present invention relates to a smoking article comprising a smoking article wrapper according to the preamble of present claim 1.

Smoking articles such as cigarettes are consumer goods produced in large quantities. They usually comprise a tobacco rod formed by wrapping tobacco cut filler with a paper based wrapper in a longitudinally extending substantially cylindrical rod. Beyond their primary tobacco wrapping function, paper based smoking article wrappers also often form a communication support for manufacturers and may comprise various printed designs, colours and/or markings (watermarks, embossing etc. . . . ), which may form part of branding features allowing consumers to recognize products among others. Thus, it is highly appreciated to provide visual effects on the cigarette paper to allow delimitation with respect to cigarettes from other brands or to provide premium appearance of the cigarettes and/or the cigarette paper. Especially embossing is requested, since it allows application of visual effects as well as haptic effects. Furthermore, deep embossing is associated by the consumer with a valuable product.

In the following the terms “smoking article” and “cigarette” are used synonymously. Some embodiments of the invention are only described for a cigarette or a cigarette paper.

However, these embodiments should be considered to be applicable and disclosed also for any other smoking article and/or smoking article wrapper.

From document CN 101 581 062 A an embossed cigarette packaging material and a method for producing such a material is known. The depth of the embossing is in the range of 5 to 50 μm. It is further disclosed that the air permeability of the cigarette packaging material could be controlled by electrostatic punching or laser drilling.

Due to the local compression of a base paper during the embossing procedure, the fibres of the paper are brought closer together. It is essential for the embossing that the fibres remain in this compressed state, even after application of the pressure. Due to the reduced distance between the fibres of the paper, embossing reduces the effective diameter of pores formed within the paper. Thus, embossing reduces the porosity of a paper and accordingly also its air permeability. However, a defined air permeability has to be guaranteed for a cigarette paper. The permeability of cigarette papers is defined as the measure of the volume of air that flows through a specified area of cigarette paper in a given unit of time. The permeability is usually given in CORESTA units (C.U.). A CORESTA Unit is defined as “the volumetric flow rate of air (cm³ min⁻¹) passing through a 1 cm² sample of substrate at an applied pressure difference of 1 kPa”. For most cigarette papers it is desired that they provide a mean volumetric flow rate of at least 20 cm³ min⁻¹ air passing through sample of 1 cm² of this cigarette paper at an applied pressure difference of 1 kPa (or 20 C.U.).

To fulfil the requirements of reduced fire risk, it is requested in some countries that the cigarettes are self-extinguishing. A major feature to ensure self-extinguishing properties of a cigarette is a controlled low air permeability of the cigarette paper. If the air permeability of the cigarette paper is low at least in some parts, the amount of air passing through the paper is not high enough to maintain it burning, unless the user is periodically intensifying the flame by inhaling.

### BRIEF SUMMARY OF THE INVENTION

However, it has been found that a higher porosity of the smoking article wrapper is advantageous to reduce the amount of nicotine, tar and carbon monoxide of a cigarette.

Furthermore, a higher porosity of the smoking article wrapper results in slower burning of a cigarette.

Comparatively, experiments of the applicant have revealed, that a perforated cigarette paper increases the amount of nicotine, tar and carbon monoxide produced during consumption of a cigarette in contrast to a non-perforated porous cigarette paper having a similar CU-value.

It is therefore the objective of the present invention to provide an embossed smoking article wrapper and a method for producing such a smoking article wrapper providing a high mean air permeability even without perforations. Furthermore, it is an objective of the present invention to provide a smoking article comprising such a smoking article wrapper.

The afore-mentioned problems are solved by a smoking article wrapper comprising a non-perforated air permeable base paper having a naturally high porosity of 40-80 cm³ min⁻¹ air passing through a sample of 1 cm² of this base paper at an applied pressure difference of 1 kPa, wherein the smoking article wrapper has at least one embossed surface area and at least one non-embossed surface area and the air permeability of the smoking article wrapper is such that it provides a mean volumetric flow rate of ≥40 cm³ min⁻¹ air passing through a sample of 1 cm² of this smoking article wrapper at an applied pressure difference of 1 kPa and the embossed surface area comprises an embossing having a depth of ≥16 μm.

It has been found, that even an embossing having a depth of ≥16 μm could be applied locally to a base paper without reducing the mean volumetric flow rate below 40 CU. Thus, perforation is not required to maintain the mean volumetric flow rate in the high range, in which the amount of nicotine, tar and carbon monoxide produced during consumption of a cigarette are lower. Furthermore, no additional apparatus is necessary for perforating the smoking article wrapper to maintain the high mean volumetric flow rate. A further advantage of smoking articles having such a wrapper as outer surface is that those smoking articles provide an enhanced visual appearance and could easily be recognized by the consumer.

In a preferred embodiment of the smoking article wrapper, the smoking article wrapper provides an air permeability in the range of a mean volumetric flow rate of 40-60 cm³ min⁻¹ air passing through a sample of 1 cm² of this smoking article wrapper at an applied pressure difference of 1 kP. It has been found that a flow rate in this range could be provided in combination with the deep embossing and allows self-extinguishing of the smoking article in combination with slow burning rates, which allows a longer smoking time for the consumer.

In a preferred embodiment of the smoking article wrapper the embossing has a depth in the range of 16-30 μm, preferably in the range of 18-28 μm, most preferably in the range of 19-25 μm. An embossing having this depth is advantageous since depths in the above-mentioned range could easily be recognized visually and haptically by a consumer.

Embossing in the above-mentioned depth range provide a luxury appearance and do not result in worsened handling properties.

Often increased base paper weight correlates with lower CU values. In contrast thereto, light weight base papers often have reduced embossing properties since they could be damaged during the embossing process or the total high of these papers is basically too low to apply deep embossing of the depth as defined above. It has been found, that base papers having a weight of 25-60 g/m² are especially suitable for producing a smoking article wrapper as defined above. Thus, in a preferred embodiment of the smoking article wrapper, the base paper has a weight of 25-60 g/m², preferably 30-50 g/m², more preferably 35-45 g/m². Base papers of this weight are not only especially suitable for embossing but usually also provide other advantageous features like a sufficient opacity, by which it could be avoided that the brownish tobacco shines through the cigarette paper locally. Thus, an unfavorable dirty or even unhygienic appearance could be avoided.

To avoid the brownish tobacco from shining through the cigarette paper locally, it is preferred that the base paper comprises a filler. In a preferred embodiment of the smoking article wrapper, the filler content of the base paper is 30-60% (w/w), preferably 35-55% (w/w), more preferably 40-50% (w/w), most preferably 40-47% (w/w).

In a preferred embodiment of the smoking article wrapper, the percentage of the embossed surface area is less than 50% of the total surface area of the smoking article wrapper, preferably less than 40%, more preferably less than 35%, and most preferably in the range of 5% to 35%. Embossing of this dimension are preferred since these percentages allow for writings and/or illustrations on the cigarette paper. Furthermore, the required permeability of the cigarette paper is maintained. Higher percentages of the embossed area result at least in some cases in reduced permeability of the cigarette paper, which could result in unwanted ignition of the cigarette.

In a preferred embodiment of the smoking article wrapper, the non-embossed surface area of the base paper provides an air permeability in the range of a mean volumetric flow rate of 42-75 cm³ min⁻¹, preferably 45-70 cm³ min⁻¹ air passing through a sample of 1 cm² of this base paper at an applied pressure difference of 1 kPa. It has been found that this air permeability is sufficiently high that even after application of the embossing, the mean volumetric flow rate of air passing through this smoking article wrapper is high enough and the burning time is longer.

A further of the above-mentioned problems is solved by a smoking article, which comprises a smoking article wrapper as described above. A smoking article comprising such a smoking article wrapper provides an enhanced visual appearance and could easily be recognized by the consumer. It provides a high-value and/or premium-quality appearance and could easily be recognized by the consumer. Because of the embossing the applied structures, symbols and/or letters could not only be recognized visually but also haptically.

Since the base paper has a weight of 25-60 g/m², preferably 30-50 g/m², more preferably 35-45 g/m² and/or comprises a filler, wherein preferably the filler content is 30-60% (w/w), preferably 35-55% (w/w), more preferably 40-50% (w/w), most preferably 40-47% (w/w), the paper as such has no transparent or semi-transparent segments. Accordingly, such a smoking article does not have the disadvantage that the brownish tobacco colour could be seen through the smoking article wrapper. Thus, brownish areas, which probably could be considered to be dirty or even unhygienic, are obviated. This further increases the high-value and/or premium-quality appearance.

Preferably, the smoking article comprises a mouthpiece and an aerosol generating substrate, wherein the aerosol generating substrate is wrapped in the smoking article wrapper as described above. Preferably, the aerosol generating substrate is tobacco or comprises tobacco. The aerosol generating substrate is heated or burnt, whereby the aerosol is generated. Wrapping the aerosol generating substrate in a cigarette paper as described above provides the possibility to improve the optical appearance of the product and/or to provide information to the consumer.

Preferably, a smoking article as described above has a CO/Tar value between 1 and 1.43. Since the mean air permeability of the smoking article wrapper is high, even after local pressure application due to the embossing procedure, the CO/Tar value could be maintained in this range.

Preferably the tar level according to DIN ISO 4387:2018-09 for such a smoking article comprising an embossed wrapper as described above is between 1 mg and 10 mg.

Another of the above-mentioned problems is solved by a method for producing a smoking article wrapper, which is permeable for air and provides a mean volumetric flow rate of ≥40 cm³ min⁻¹ air passing through a sample of 1 cm² of this smoking article wrapper at an applied pressure difference of 1 kPa. This method comprises the step of providing a non-perforated air-permeable base paper having a naturally high porosity of 40-80 cm³ min⁻¹ air passing through a sample of 1 cm² of this base paper at an applied pressure difference of 1 kPa and generating an embossing having a depth of ≥16 μm by application of pressure on parts of the surface area of the base paper. This method allows production of smoking articles having a high-value and/or premium-quality appearance at low costs. Preferably the method does not require perforation of the base paper for maintaining a high porosity of 40-80 CU. Since information for the consumer could be applied by embossing, no additional substances like pigments are needed. However, application of further substances is possible, e.g. printing of symbols and/or letters or application of substances for further increasing the high-value and/or premium-quality appearance.

In a preferred embodiment the method comprises the step of selecting a suitable base paper. The base paper preferably provides an air permeability in the range of a mean volumetric flow rate of 42-75 cm³ min⁻¹, preferably 45-70 cm³ min⁻¹ air passing through a sample of 1 cm² of this base paper at an applied pressure difference of 1 kPa and/or has a weight of 25-60 g/m², preferably 30-50 g/m², more preferably 35-45 g/m². These base papers have been found to be especially suitable for maintaining a high air permeability even after application of local embossing.

It is preferred that less than 50%, preferably less than 40%, more preferably less than 35%, and most preferably between 5% and 35% of the total surface area of the base paper are embossed. Thus, the high mean air permeability could be maintained.

In a preferred embodiment of the method, the base paper is embossed at a pressure of at least 4 MPa, preferably 5-15 MPa, more preferably 6-12 MPa. This pressure has been found to be sufficient to apply a deep embossing having a depth of ≥16 μm to the base paper. However, this pressure does not result in closure of all pores of the base paper. Thus, a sufficiently high air permeability could be maintained also in the embossed segments.

All disclosed features relating to the method shall apply mutatis mutandis to the smoking article wrapper and/or the smoking article and all disclosed features relating to the smoking article wrapper and/or the smoking article shall apply mutatis mutandis to the method.

Another of the above-mentioned problems is solved by a method for producing a smoking article comprising a smoking article wrapper according to any of the previously described embodiments. The method is characterized by the steps
manufacturing a smoking article wrapper according to at least one of the previously described methods,
providing a mouthpiece and an aerosol generating substrate
wrapping the aerosol generating substrate in the smoking article wrapper.

### BRIEF DESCRIPTION OF THE DRAWINGS

Further advantages, objectives and features of the present invention will be described, by way of example only, in the following description with reference to the appended figures. In the figures, like components in different embodiments can exhibit the same reference symbols.

The figures show:

FIG. 1a an image of an exemplary embodiment of a smoking article wrapper according to the invention;

FIG. 1b an image of an exemplary smoking article wrapper having a similar but less deep embossing pattern than the smoking article wrapper of FIG. 1a;

FIG. 2a an image of a further exemplary embodiment of a smoking article wrapper according to the invention;

FIG. 2b an image of a further exemplary smoking article wrapper having a similar but less deep embossing pattern than the smoking article wrapper of FIG. 2a;

FIG. 3a a detailed image of the embossing as illustrated in FIG. 1a;

FIG. 3b a diagram showing the height profile of the smoking article wrapper as illustrated in FIG. 3a along the indicated path 13;

FIG. 4a a detailed image of the embossing as illustrated in FIG. 2b;

FIG. 4b a diagram showing the height profile of the smoking article wrapper as illustrated in FIG. 4a along the indicated path 13;

FIG. 5 a diagram showing the relation between the porosity of smoking article wrapper and its surface area covered by embossed features.

### DETAILED DESCRIPTION

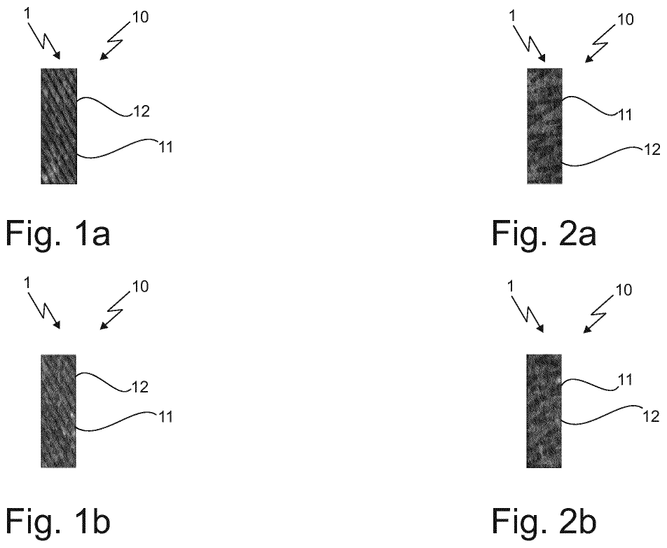

FIG. 1a shows an image of an exemplary embodiment of a smoking article wrapper 1 according to the invention. To obtain the picture of FIG. 1a, the smoking article wrapper 1 was illuminated from the backside. Thus, FIG. 1a can give hints about the opacity of different areas of the smoking article wrapper 1. In FIG. 1a only a small sample of a smoking article wrapper 1 is shown. Such a smoking article wrapper 1 could be part of a smoking article. Usually such smoking article wrapper 1 is produced as a continuous band of paper-based material wound in a bobbin or equivalently reeled fashion. During production of smoking articles such as cigarettes the band is unreeled in a smoking article machine to wrap a continuous strand of aerosol-generating material, for example of tobacco material, which is then cut in rods to form a plurality of smoking articles.

The illustrated smoking article wrapper 1 has an embossing. The pattern 10 of the embossing consists of a plurality of parallel lines 11. Due to the applied pressure during the embossing procedure, the base paper material is highly compressed in these areas. Less light is shining through the smoking article wrapper 1 in the embossed areas 11. Thus, these areas are darker than the non-embossed areas 12. Due to the depth of the embossing and the high compression of the base paper material in these areas, the embossed lines 11 occur homogeneously black. In contrast thereto, the non-embossed areas 12 are less homogeneous, due to the chaotical arrangement of the base material fibers of the base paper. Since the fibers of the base paper material are stacked higher in some areas than in others, less light is transmitted in these areas. Due to the higher amount of light absorbing material arranged in these areas, these areas occur darker than the others.

FIG. 1b shows an image of an exemplary smoking article wrapper 1 having a similar or even the same pattern 10 of the embossing as the smoking article wrapper shown in FIG. 1a. However, the depth of the embossing 11 is lower. The pressure for application of the embossing 10 was lower than that used for application of the embossing 10 as illustrated in FIG. 1a. As a result of the reduced pressure, the contrast of light transmission between the embossed areas 11 and the non-embossed areas 12 is low. In contrast to the smoking article wrapper shown in FIG. 1a, the embossed lines 11 occur lighter and they are interrupted often.

Due to the higher contrast and the improved haptical properties of a deeper embossing, a smoking article comprising a wrapper having such an embossing may appear more valuable to smoking articles consumers. A luxury appearance could be established.

FIGS. 2a and 2b show further exemplary embodiments of smoking article wrappers 1 according to the invention. Similar to the embodiment shown in FIG. 1a, the smoking article wrappers 1 are illuminated from the backside and the opacity of different areas 11, 12 of the smoking article wrapper 1 could be recognized. The pattern 10 of the embossing differs from the pattern shown in FIGS. 1a and 1b. It consists of a plurality of lines 11 forming the letter “W”.

Like FIGS. 1a and 1b, also the embossing shown in FIG. 2a is applied at higher pressure than that shown in FIG. 2b. Due to the higher pressure for application of the embossing 10 shown in FIG. 2a, the letter “W” is well identifiable in FIG. 2a. In FIG. 2b, the letter “W” could only be determined in some areas. The contrast is low, especially at the ends of each line and those areas where the lines get close to each other.

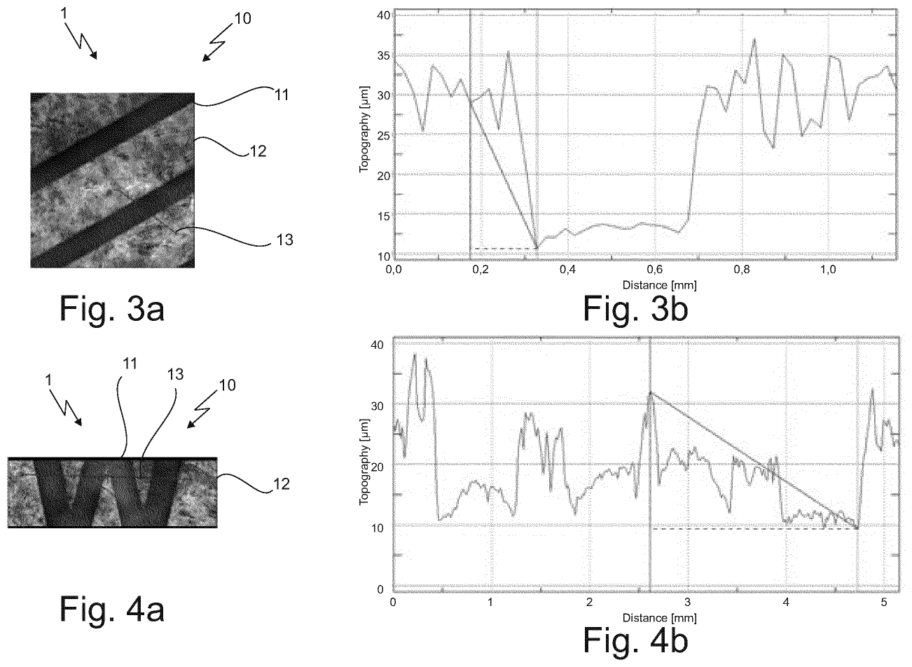

A detailed analysis of the height profile of a smoking article wrapper 1 according to the invention is shown in FIG. 3a-4b. FIG. 3a shows a cut-out of the smoking article wrapper 1 as shown in FIG. 1a in more detail. FIG. 4a shows a cut-out of the smoking article wrapper 1 as shown in FIG. 2b in more detail. At this higher magnification the pattern 10 of the embossing could be clearly recognized for both examples. The lines 11 appear dark in contrast to the non-embossed areas 12. In the non-embossed areas, even single fibres of the base paper could be recognized. Due to the chaotical arrangement of these fibres, the transmitted light in the non-embossed areas 12 is erratic and these areas 12 appear irregularly.

FIG. 3b shows a diagram illustrating the height profile of the smoking article wrapper 1 as illustrated in FIG. 3a along the indicated path 13. The abscissa indicates the distance (in mm) along the path 13 (of FIG. 3a) and the ordinate the height (in μm) of the smoking article wrapper 1 at the respective point. As it could already be assumed because of the non-uniform opacity, the height of the non-embossed areas 12 of the smoking article wrapper 1 differs along the path 13. However, the height is mostly within a corridor between about 25 μm and 35 μm. The height of the embossed area 11 is much lower. Also, the variation of the height is lower in this area. Thus, the height of the embossed area 12 is mainly within a corridor between about 12 and 14 μm. This also explains the very homogeneous opacity of the embossing as illustrated in FIG. 1a.

FIG. 4b shows a diagram illustrating the height profile of the smoking article wrapper 1 as illustrated in FIG. 4a along the indicated path 13. Like FIG. 3b, the abscissa indicates the distance (in mm) along the path 13 (of FIG. 4a) and the ordinate the height (in μm) of the smoking article wrapper 1 at the respective point. Compared to the diagram of FIG. 3a, the height of the non-embossed areas 12 is even more irregular. Also, the height of the embossed areas 11 is more irregular. Approximating the height profile of the embossed areas results to a curve profile, having its maximal height in the middle or next to the middle of the respective embossed structure. The height of the non-embossed area 12 is reduced in areas where two embossed areas 11 are close to each other. This could be caused by a compression of the base paper due to the pressure application on both sides of the non-embossed area 12. However, the non-embossed areas 12 are still visible due to its uneven height. In contrast thereto, the smoothness of the embossed areas 11 is higher and the average height lower. However, for the smoking article wrapper 1 as shown in FIG. 4a, the corridors of the height of the embossed areas 11 as well as for the non-embossed areas 12 are wider than those for the smoking article wrapper 1 as shown in FIG. 3a. The corridor of the non-embossed areas extends between about 17 μm and 38 μm and the corridor of the embossed areas extends between about 10 μm and 22 μm. These wider corridors and their partial overlap result in reduced visual and haptical perceptibility of the embossing 10 on the surface of the smoking article wrapper 1. Thus, a product comprising such a smoking article wrapper 1 is usually considered to be less valuable by the consumer and no luxury appearance could be established.

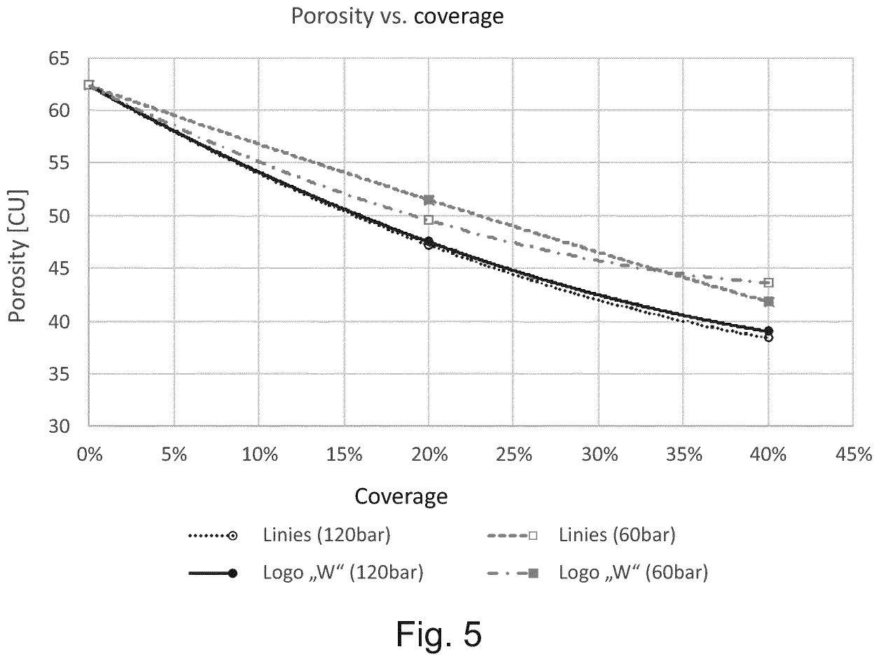

FIG. 5 illustrate the relation between the porosity of a smoking article wrapper and its surface area covered by an embossed pattern as per FIG. 1 or 2. Since the fibres of a base paper are compressed during and after application of an embossing, pores between the fibres are closed. The portion of closed pores strongly depend from the applied pressure. Furthermore, the pattern of the embossing influences the portion of closed pores. However, as it can be derived from FIG. 5, the influence of the pattern is strongly dependent from the applied pressure.

The base paper without any embossing has a porosity of about 62 CU. As explained above, this porosity gets lower after application of embossing. The degression of the porosity depends on the applied pressure. After embossing at a pressure of 120 bar (circles) the porosity is greatly reduced. This reduction of porosity is nearly independent from the applied pattern (empty circles (parallel lines) versus filled dots (“W”-pattern)). Based on the measured points a polynomial approximation results in the respective curves (dotted line (parallel lines) vs. solid line (“W”-pattern)). Both curves are very similar and differences in porosity are marginal. This could easily be explained with the assumption that at high pressures all pores of the base paper are closed, independent from the pattern.

In contrast thereto, the pattern of the embossing has an effect to the porosity if applied at medium high pressure. Based on the measured points (shown as grey empty squares (parallel lines) versus grey filled squares (“W”-pattern)) of the porosity of the smoking article wrapper 1 after application of embossing at 60 bar, polynomial approximation curves were calculated ( - - - (parallel lines) vs. - ⋅ - ⋅ - (“W”-pattern)). The shapes of both curves differ from each other. For both curves (60 bar) the porosity is always higher than for the both curves indicating the trend of the porosity after embossing at 120 bar.

Furthermore, it is noted that in the figures features are described, which can be advantageous individually. Someone skilled in the art will directly recognize that a specific feature being disclosed in a figure can be advantageous also without the adoption of further features from this figure. Furthermore, someone skilled in the art will recognize that advantages can evolve from a combination of diverse features being disclosed in one or various figures.

### LIST OF REFERENCE SYMBOLS

1 smoking article wrapper
10 pattern
11 embossed surface area
12 non-embossed surface area
13 path

1. A smoking article wrapper comprising a non-perforated air permeable base paper having a naturally high porosity of 40-80 cm³/min of air passing through a sample of 1 cm² of the base paper at an applied pressure difference of 1 kPa, wherein the smoking article wrapper has at least one embossed surface area and at least one non-embossed surface area,
wherein an air permeability of the smoking article wrapper provides a mean volumetric flow rate of ≥40 cm³/min of air passing through a sample of 1 cm² of the smoking article wrapper at an applied pressure difference of 1 kPa and in that the at least one embossed surface area comprises an embossing having a depth of ≥16 μm.

2. The smoking article wrapper according to claim 1,
wherein the smoking article wrapper provides an air permeability in a range of a mean volumetric flow rate of 40-60 cm³ min⁻¹ of air passing through a sample of 1 cm² of the smoking article wrapper at an applied pressure difference of 1 kPa.

3. The smoking article wrapper according to claim 1,
wherein the depth of the embossing is in a range of 16-30 μm.

4. The smoking article wrapper according to claim 1,
wherein the base paper has a weight of 25-60 g/m².

5. The smoking article wrapper according to claim 1,
wherein the at least one non-embossed surface area of the base paper provides an air permeability in a range of a mean volumetric flow rate of 42-75 cm³ min⁻¹ of air passing through a sample of 1 cm² of the base paper at an applied pressure difference of 1 kPa.

6. The smoking article wrapper according to claim 1,
wherein the base paper comprises a filler, wherein a content of the filler is 30-60% (w/w).

7. The smoking article wrapper according to claim 1,
wherein a percentage of the at least one embossed surface area is less than 50% of a total surface area of the smoking article wrapper.

8. A smoking article comprising the smoking article wrapper according to claim 1.

9. The smoking article according to claim 8,
further comprising a mouthpiece and an aerosol generating substrate, wherein the aerosol generating substrate is wrapped in the smoking article wrapper.

10. The smoking article according to claim 8,
wherein a CO/Tar value of the smoking article is between 1 and 1.43.

11. The smoking article according to claim 8,
wherein a tar level of the smoking article according to DIN ISO 4387:2018-09 is between 1 mg and 10 mg.

12. A method for producing a smoking article wrapper, which is permeable for air and provides a mean volumetric flow rate of ≥40 cm³ min⁻¹ of air passing through a sample of 1 cm² of the smoking article wrapper at an applied pressure difference of 1 kPa, comprising:
providing a non-perforated air-permeable base paper having a naturally high porosity of 40-80 cm³ min⁻¹ of air passing through a sample of 1 cm² of the base paper at an applied pressure difference of 1 kPa,
generating an embossing having a depth of ≥16 μm by application of pressure on parts of a surface area of the base paper.

13. The method according to claim 12,
wherein the smoking article wrapper provides an air permeability in a range of a mean volumetric flow rate of 42-75 cm³ min⁻¹ of air passing through a sample of 1 cm² of the base paper at an applied pressure difference of 1 kPa and/or has a weight of 25-60 g/m².

14. The method according to claim 12,
wherein the step of generating the embossing includes application of pressure on less than 50% of the surface area of the base paper.

15. The method according to claim 12,
wherein the step of generating the embossing includes application of pressure of at least 4 MPa.

16. A method for producing a smoking article, comprising:
manufacturing a smoking article wrapper with the method according to claim 12,
providing a mouthpiece and an aerosol generating substrate, and
wrapping the aerosol generating substrate in the smoking article wrapper.
